(19) United States
(12) Patent Application Publication
(10) Pub. No.: US 2016/0179351 A1
(43) Pub. Date: Jun. 23, 2016

(54) ZONES FOR A COLLABORATION SESSION IN AN INTERACTIVE WORKSPACE

(71) Applicant: SMART Technologies ULC, Calgary (CA)

(72) Inventors: ERICA ARNOLDIN, Calgary (CA); KATHRYN ROUNDING, Calgary (CA); COLIN DERE, Calgary (CA)

(21) Appl. No.: 14/964,885

(22) Filed: Dec. 10, 2015

Related U.S. Application Data
(60) Provisional application No. 62/094,970, filed on Dec. 20, 2014.

(51) Int. Cl. G06F 3/0484; G06F 3/0488

(52) U.S. Cl. CPC G06F 3/04845; G06F 3/04842; G06F 3/04886

(57) ABSTRACT

A method is provided for automatically grouping objects on a canvas in a collaborative workspace. At least one zone is defined within the canvas into which at least a subset of a plurality of users of the collaborative workspace can contribute content. In response to a user-based manipulation of the zone, all of the content contained within the zone is automatically manipulated. In response to a user-based manipulation, by one of the subset of the plurality of users, of selected ones the content within the zone, only the selected ones of the content are manipulated. An interactive input system configured to implement the method is also provided.

This application claims priority to U.S. Provisional Application No. 62/094,970 filed Dec. 20, 2014. The present invention relates generally collaboration within an interactive workspace, and in particular to a to a system and method for facilitating collaboration by provide zones within the interactive workspace.

### BACKGROUND

Interactive input systems that allow users to inject input (e.g., digital ink, mouse events etc.) into an application program using an active pointer (e.g., a pointer that emits light, sound, or other signal), a passive pointer (e.g., a finger, cylinder or other suitable object) or other suitable input devices such as for example, a mouse, or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies of ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones; personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital imaging devices at its corners. The digital imaging devices have overlapping fields of view that encompass and look generally across the touch surface. The digital imaging devices acquire images looking across the touch surface from different vantages and generate image data. Image data acquired by the digital imaging devices is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In such a multi-touch interactive input system, the machine vision system captures images including the point(s) of escaped light, and processes the images to identify the touch position on the waveguide surface based on the point(s) of escaped light for use as input to application programs.

The application program with which the users interact provides a canvas for receiving user input. The canvas is configured to be extended in size within its two-dimensional plane to accommodate new input as needed. As will be understood, the ability of the canvas to be extended in size within the two-dimensional plane as needed causes the canvas to appear to be generally infinite in size. Accordingly, managing the collaboration session may become burdensome, resulting in a diminished user experience.

It is therefore an object to provide a novel method of navigation during an interactive input session and a novel interactive board employing the same.

### SUMMARY OF THE INVENTION

According to an aspect there is provided a method for automatically grouping objects on a canvas in an collaborative workspace, the method comprising: defining at least one zone within the canvas into which a plurality of users can contribute content; in response to a user-based manipulation of the zone, automatically manipulating all of the content contained within the zone; and in response to a user-based manipulation of selected ones the content with the zone, manipulating only the selected ones of the content.

If a plurality of zones has been defined, then at least a pair of the plurality of zones may overlap. The overlapping section of the pair of zones behaves as a combined set of the restrictions of each of the pair of zones.

In accordance with another aspect, there is provided an interactive input system comprising: a touch surface; memory comprising computer readable instructions; and a processor configured to implement the computer readable instructions to: provide a canvas on the touch surface via which a plurality of users can collaborate; define at least one zone within the canvas into which users can contribute content; in response to a user-based manipulation of the at least one zone, automatically manipulate the content contained with the at least one zone; and in response to a user-based manipulation of selected ones the content with the at least one zone, automatically manipulate only the selected ones of the content.

### BRIEF DESCRIPTION OF THE DRAWINGS

Embodiments of the invention will now be described by way of example only with reference to the accompanying drawings in which:

FIG. 1a is a diagram of an interactive input system;

FIG. 1b is a diagram of a collaboration system;

FIG. 1c is a diagram of the components of a collaboration application;

FIG. 2 is diagram of an exemplary web browser application window;

FIGS. 3a-3d are diagrams illustrating different types of zones;

FIG. 4 is a diagram illustrating how zones can be applied to a plan; and

FIG. 5 is a flow chart illustrating automatic grouping of the zones for manipulation.

### DETAILED DESCRIPTION OF THE EMBODIMENTS

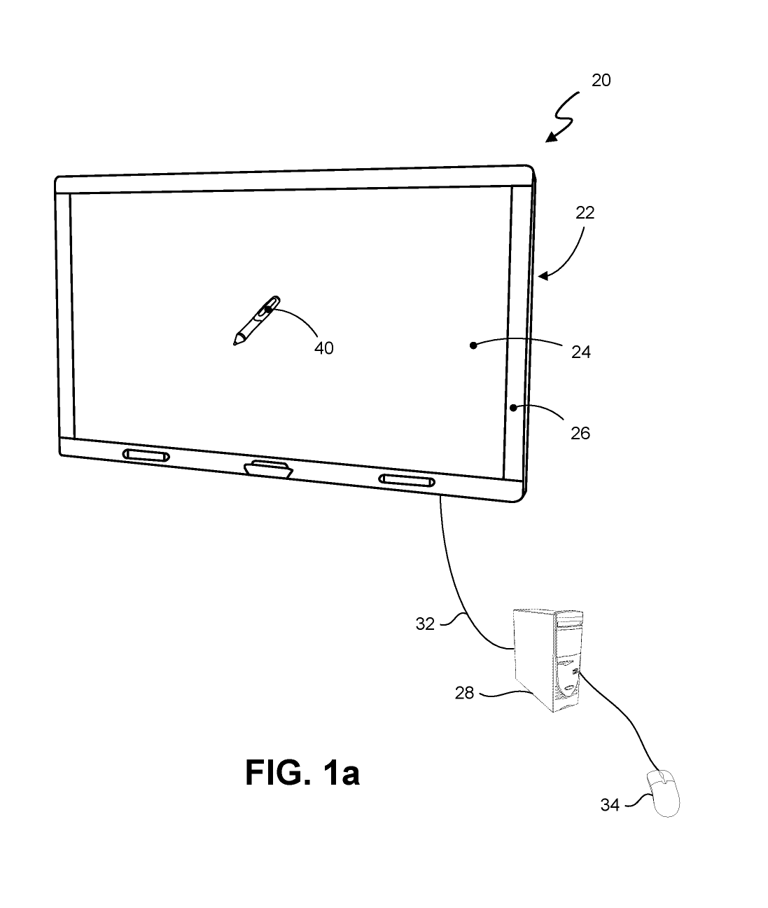

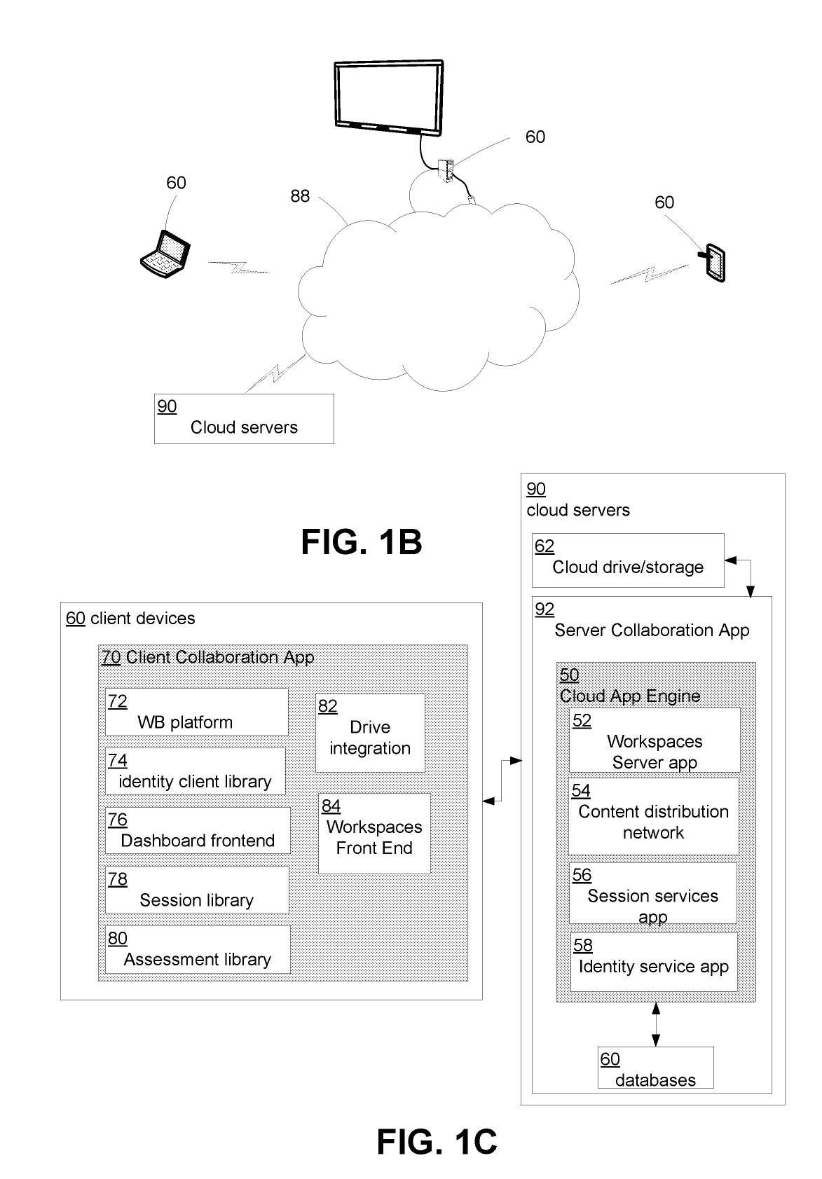

For convenience, like numerals in the description refer to like structures in the drawings. Referring to FIG. 1, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise suspended or supported in an upright orientation. Interactive board 22 comprises a generally planar, rectangular interactive surface 24 that is surrounded about its periphery by a bezel 26. An image, such as for example a computer desktop is displayed on the interactive surface 24. In this embodiment, a liquid crystal display (LCD) panel or other suitable display device displays the image, the display surface of which defines interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 32 or other suitable wired or wireless communication link. General purpose computing device 28 processes the output of the interactive board 22 and adjusts image data that is output to the interactive board 22, if required, so that the image presented on the interactive surface 24 reflects pointer activity. In this manner, the interactive board 22 and general purpose computing device 28 allow pointer activity proximate to the interactive surface 24 to be recorded as writing or drawing or used to control execution of one or more application programs executed by the general purpose computing device 28.

Imaging assemblies (not shown) are accommodated by the bezel 26, with each imaging assembly being positioned adjacent a different corner of the bezel. Each imaging assembly comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. The imaging assemblies are oriented so that their fields of view overlap and look generally across the entire interactive surface 24. In this manner, any pointer such as for example a user's finger, a cylinder or other suitable object, a pen tool 40 or an eraser tool that is brought into proximity of the interactive surface 24 appears in the fields of view of the imaging assemblies and thus, is captured in image frames acquired by multiple imaging assemblies.

When the imaging assemblies acquire image frames in which a pointer exists, the imaging assemblies convey the image frames to a master controller. The master controller in turn processes the image frames to determine the position of the pointer in (x,y) coordinates relative to the interactive surface 24 using triangulation. The pointer coordinates are then conveyed to the general purpose computing device 28 which uses the pointer coordinates to update the image displayed on the interactive surface 24 if appropriate. Pointer contacts on the interactive surface 24 can therefore be recorded as writing or drawing or used to control execution of application programs running on the general purpose computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 28 may also comprise networking capability using Ethernet, WiFi, and/or other network format, for connection to access shared or remote drives, one or more networked computers, or other networked devices. The general purpose computing device 28 is also connected to the World Wide Web via the Internet.

The interactive input system 20 is able to detect passive pointers such as for example, a user's finger, a cylinder or other suitable objects as well as passive and active pen tools 40 that are brought into proximity with the interactive surface 24 and within the fields of view of imaging assemblies. The user may also enter input or give commands through a mouse 34 or a keyboard (not shown) connected to the general purpose computing device 28. Other input techniques such as voice or gesture-based commands may also be used for user interaction with the interactive input system 20.

Referring to FIG. 1B, a simplified block diagram of an exemplary embodiment of a collaboration system is illustrated generally by numeral 140. In the collaboration system, client computing devices 60 are interconnected to a network of one or more cloud servers 90 via a communication network 88. Examples of the client computing devices 60 include the general purpose computing device 28, laptop or notebook computers, tablets, desktop computers, smartphones professional digital assistants (PDAs) and the like. Examples of the communication network 88 include a local area network (LAN) or a wide area network (WAN). The communication network 88 may further comprise public networks, such as the Internet, private networks, or a combination thereof.

FIG. 1C depicts some of the software components executing on the client devices 60 and cloud servers 90. In an exemplary embodiment, the client computing devices 60 are configured to run a client collaboration application 70. In an embodiment, the client collaboration application 70 is implemented in the form of a web browser application. The client collaboration application 70 is configured to interact with client software components such as whiteboard platform library 72, an identity client library 74, a dashboard frontend 76, a session library 78, an assessment library 80, a cloud drive interface module 82, and workspaces front end 84 and the like to facilitate connection of the client computing devices 60 to one or more of the cloud servers 90. The cloud servers 90 are configured to host a server collaboration application 92. As will be appreciated by a person skilled in the art, the cloud servers 90 may be one or more personal computers, one or more server computers, a network of server computers, a server farm or other suitable processing device configured to execute the server collaboration application 92. The server collaboration application 92 is configured to interact with server software components such as a cloud application engine 50, a cloud drive 62, databases 60 and the like. The cloud application engine 50 may further include a workspaces server application 52, a content distribution network 54, a sessions servers application 56, and an identity service application 58 (also known as SMART ID service), and the like. The server collaboration application 92 facilitates establishing a collaboration session between the client computing devices 60 via the remote host servers or cloud servers 90 and the communication network 88. As will be appreciated, different types of client computing devices 60 may connect to the cloud servers 90 to join the same collaboration session.

One or more participants can join the collaboration session by connecting their respective client computing devices 60 to the cloud server 90 via web browser applications running thereon. Participants of the collaboration session can all be co-located at a common site, or can alternatively be located at different sites. It will be understood that the computing devices may run any operating system such as Microsoft Windows™, Apple iOS, Apple OS X, Linux, Android and the like. The web browser applications running on the computing devices provide an interface to the remote host server, regardless of the operating system.

When a computing device user wishes to join the collaborative session, the client collaboration application 70 is launched on the computing device. Since, in this embodiment, the client collaboration application is in the form of a web browser application, an address of an instance of the server collaboration application 92, usually in the form of a uniform resource locator (URL), is entered into the web browser. This action results in a collaborative session join request being sent to the cloud server 90. In response, the cloud server 90 returns code, such as HTML5 code, to the client computing device 60. The web browser application launched on the computing device 60 in turn parses and executes the received code to display a shared two-dimensional workspace of the collaboration application within a window provided by the web browser application. The web browser application also displays functional menu items, buttons and the like within the window for selection by the user. Each collaboration session has a unique identifier associated with it, allowing multiple users to remotely connect to the collaboration session. The unique identifier forms part of the URL address of the collaboration session. For example, the URL “canvas.smartlabs.mobi/default.cshtml?c=270” identifies a collaboration session that has an identifier 270. Session data may be stored on the cloud server 90 and may be associated with the session identified by the session identifier during hypertext transfer protocol (HTTP) requests from any of the client devices 60 that have joined the session.

The server collaboration application 92 communicates with each computing device joined to the collaboration session, and shares content of the collaboration session therewith. During the collaboration session, the collaboration application provides the two-dimensional workspace, referred to herein as a canvas, onto which input may be made by participants of the collaboration session using their respective client devices 60. The canvas is shared by all computing devices joined to the collaboration session.

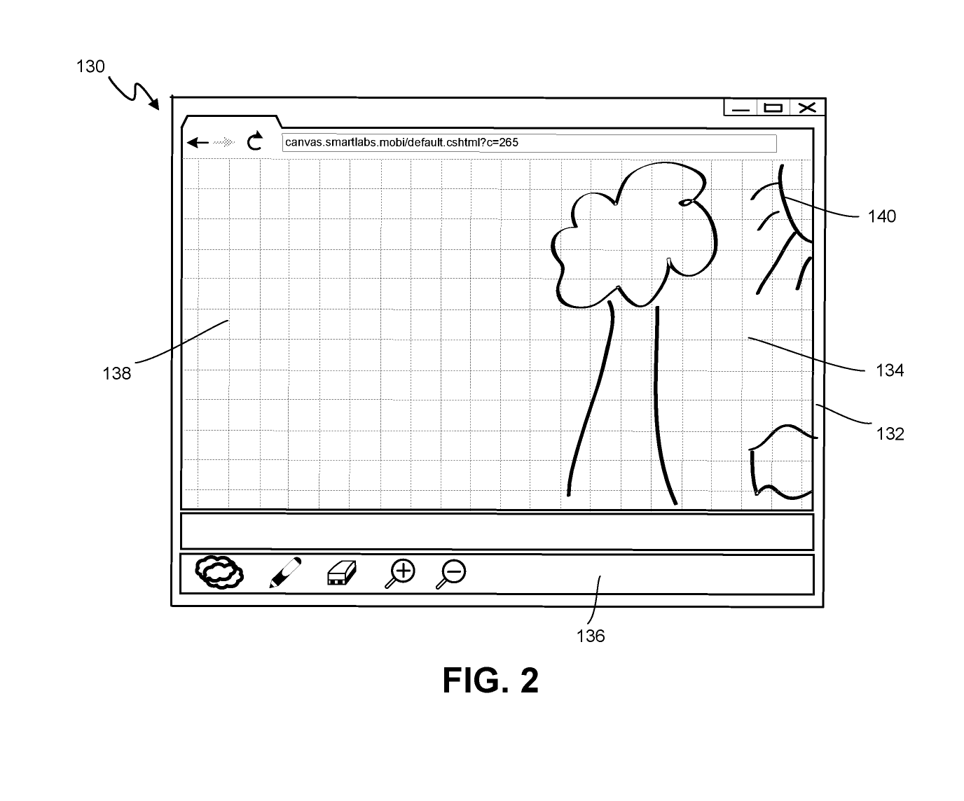

Referring to FIG. 2, an exemplary web browser application window is illustrated generally by numeral 130. The web browser application window 130 is displayed on the interactive surface 24 when the general purpose computing device 28 connects to the collaboration session. The web browser application window 130 comprises an input area 132 in which a portion of the canvas 134 is displayed. In the example shown in FIG. 2, the portion of the canvas 134 has input thereon in the form of digital ink 140. The canvas 134 also comprises a reference grid 138, over which the digital ink 140 is applied. The web browser application window 130 also comprises a menu bar 136 providing a plurality of selectable icons, with each icon providing a respective function or group of functions.

Only a portion of the canvas 134 is displayed because the canvas 134 is configured to be extended in size within its two-dimensional plane to accommodate new input as needed during the collaboration session. As will be understood, the ability of the canvas 134 to be extended in size within the two-dimensional plane as needed causes the canvas to appear to be generally infinite in size.

Each of the participants in the collaboration application can change the portion of the portion of the canvas 134 presented on their computing devices, independently of the other participants, through pointer interaction therewith. For example, the collaboration application, in response to one finger held down on the canvas 134, pans the canvas 134 continuously. The collaboration application is also able to recognize a “flicking” gesture, namely movement of a finger in a quick sliding motion over the canvas 134. The collaboration application, in response to the flicking gesture, causes the canvas 134 to be smoothly moved to a new portion displayed within the web browser application window 130.

However, one of the challenges when working in an extremely large or infinite space is organizing and managing the large amounts of content that may be created or added. Furthermore, once that space becomes collaborative, the challenge of managing users is added. The terms “user” and “participant” will be used interchangeably herein. Accordingly, the canvas is divided into a number of zones. Each zone is a defined area within the canvas that can group both content and participants and provide different levels of restrictions on them. As will be described, using zones facilitates several techniques that can be used to help manage both content and participants in a large shared space.

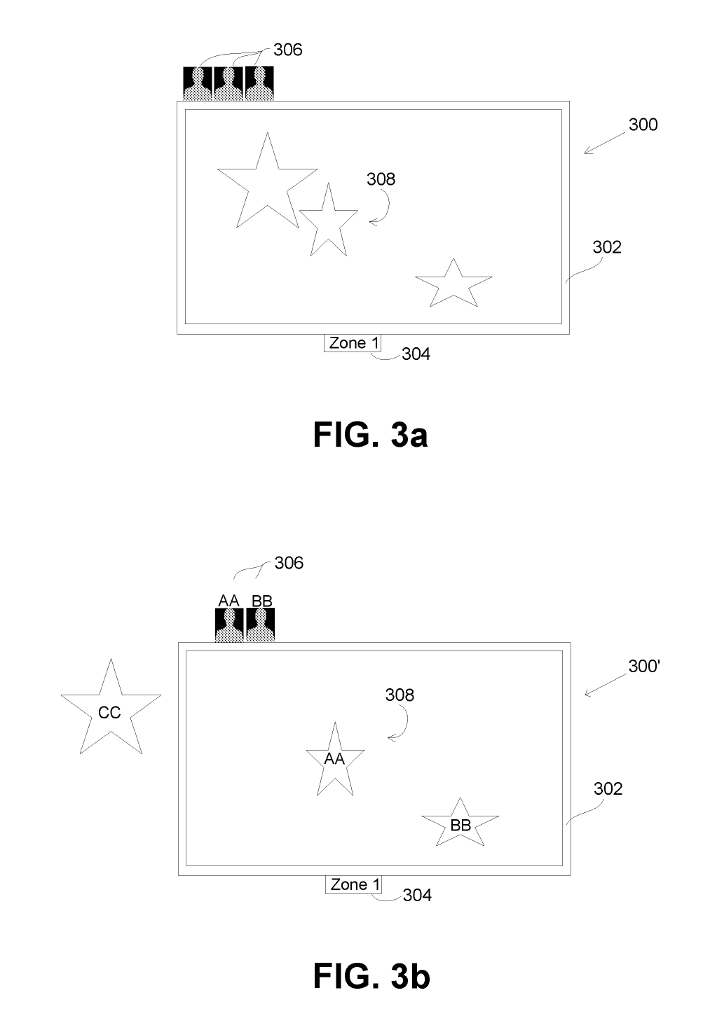

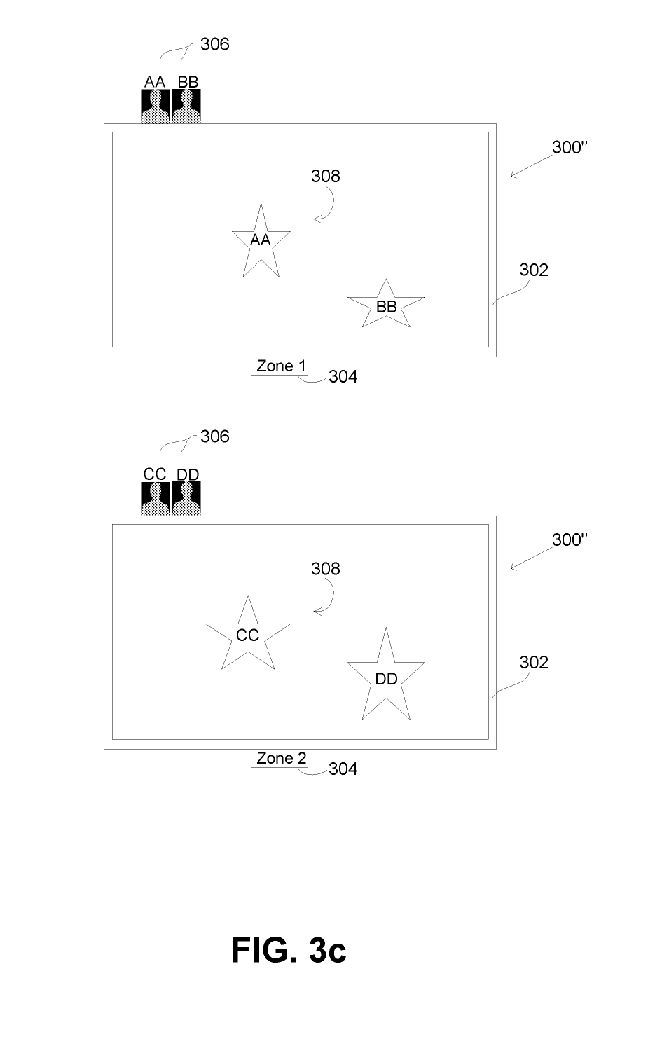

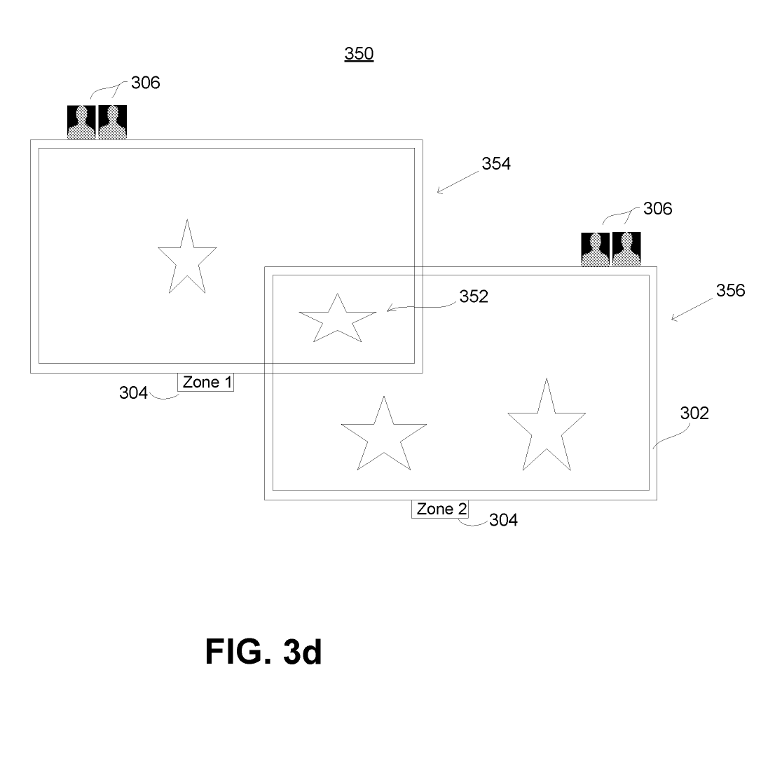

Referring to FIG. 3a, a basic zone is illustrated generally by numeral 300. The zone 300 is a predefined defined area in which content 308 can be placed by one or more users. The zone 300 includes a boundary 302. The boundary 302 may be visible to the users. The zone 300 also includes a label 304 identifying the zone 300. The label 304 may be visible to the users. The zone 300 may also include user icons 306 representing the users. The user icons 306 may be displayed proximate the boundary 302. In an embodiment, the user icons 306 are displayed outside of the boundary 302 to avoid overlapping with the content 308 placed within the zone 300. The user icons 306 may comprise avatars, images and the like, either defined by the users or automatically selected by the collaboration application. Any of the users accessing the collaboration application can view and interact with the zone 300. In an embodiment in which the zone 300 includes the display of the user icons 306, the user icons 306 may be displayed in a number of different ways. For example, the user icons 306 representing all of the users accessing the collaboration application may be displayed. Alternatively, only the user icons 306 representing the users who have contributed to the zone 300 may be displayed. In this example, users will readily be able to determine which users are participating in which of the zones 300.

Any content 308 added to the zone 300 is automatically correlated with the zone 300. When manipulating the zone 300, all of its content 308 is treated as a group and can be moved, hidden, shown or modified as a single group. At the same time, the ability to manage individual content is retained.

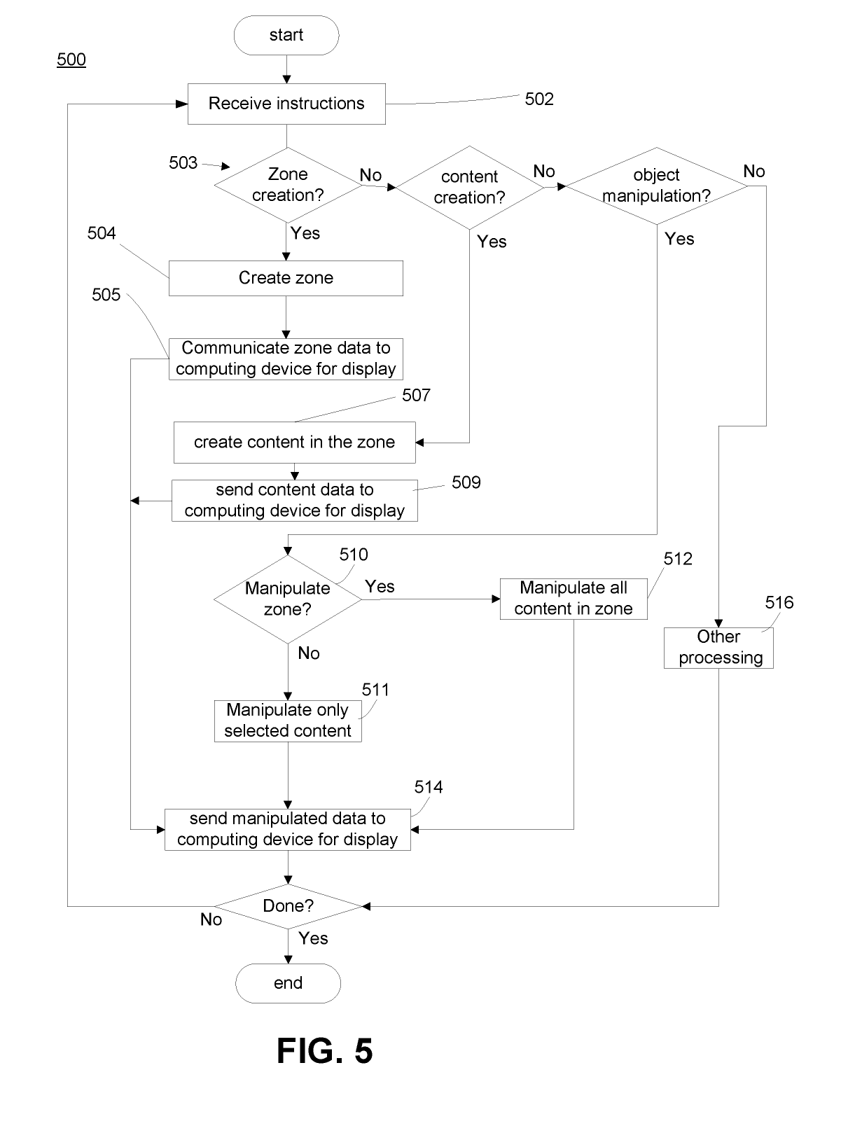

Referring to FIG. 5, a flow chart illustrating a method for automatically grouping and manipulating objects by the server collaboration application 92 in a collaborative workspace is illustrated generally by numeral 500. At 502, the server collaboration application 92 receives instructions from a client collaboration application 70. At 503, the server collaboration application 92 determines the nature of the received instructions. If the received instructions relate to zone construction, then, at 504, a zone is created in the collaborative workspace accordingly. At 505, zone data associated with the created zone is communicated to the client collaboration application 70 for display on the client computing device 60.

Returning to 503, if the received instructions relate to content creation for a specified zone, then, at 507, content is created within the zone. At 509 content data associated with the created content is communicated to the client collaboration application 70 for display in the zone on the client computing device 60.

Returning again to 503, if the received instructions relate to content manipulation, then, at 510, it is determined if the zone is to be manipulated. If the zone is to be manipulated then at 512, all the content in the zone is automatically manipulated. This can be accomplished, for example, by registering event handlers of the content 308 with event handers of the zone 300 when the content 308 is added to the zone 300. Thus, any manipulation of the zone 300 can be automatically communicated to the event handlers of the content 308. When the content 308 is deleted or removed from the zone 300, the corresponding event handlers of the removed content 308 are deregistered from the event handers of the zone 300.

If the zone is not to be manipulated then, at step 511, only the selected content is manipulated. At 514, the manipulated content is communicated to the client collaboration application 70 for display on the client computing device 60.

Returning again to 503, if the received instructions relate to something other than zone creation, content creation or content manipulation, then, at 516, the instructions are processed accordingly.

The ability to automatically manipulate all of the content 308 within the zone by manipulating the zone 300 provides the advantages of multiple object selection and grouping, without the difficulties inherent in those two actions. Specifically, multiple object selection involves complicated algorithms and modifier keys to get the desired effect. Grouping often means that the group must be ungrouped to be edited and then the desired multiple objects must be selected again to be regrouped. Multiple object selection is especially hard on touch devices without modifier keys. With the zones 300, as described above, both of these challenges could be eased, while still allowing for easy grouping and reorganizing of items.

A number of different types of zone 300 can be defined, each type of zone differing in restrictions and permissions applied to the zone 300. The restrictions and permissions are applied to the users accessing the canvas within the collaboration application. However, an administrator of the collaboration application can define super users, to whom the restrictions and permissions of the different types of zones 300 do not apply. For example, in a classroom environment, students may be designated as users and a teacher may be designated as a super user. In this manner, the students will be restricted by the restrictions and permissions applied to the zones 300 and the teacher will not be bound by the same restrictions and permissions.

For example, referring to FIG. 3b, a contribution zone is shown generally by numeral 300′. The contribution zone 300′ includes all of the properties of the zone 300. However, only authorized or predefined users can provide the content 308 to the contribution zone 300′ or manipulate the content 308 within the contribution zone 300′. Thus, only a predefined subset of the users will be permitted to contribute to the contribution zone 300′. In an embodiment, the users permitted to contribute to the contribution zone 300′ are identified by the user icons 306. As shown in FIG. 3b, users AA and BB are authorized to provide the content 308, and the content provided by user AA and user BB is included in the contribution zone 300′.

When a user who does not have access to the contribution zone 300′, referred to as an unauthorized user, attempts to provide content to contribution zone 300′, the content is not accepted. The unauthorized user may be presented with a notification, in the form of a pop-up text for example, advising the user that s/he is not permitted to add content to the contribution zone 300′. Alternatively, any content added to the contribution zone 300′ by an unauthorized user may be moved from the contribution zone 300′ and placed outside of it. The movement of the content from an unauthorized user may be performed after a small delay so as to create a “bouncing” or “repelling” visual effect from inside the contribution zone 300′ to outside the contribution zone. As shown in FIG. 3b, the content 308 provided by unauthorized user CC is excluded from the contribution zone 300′.

If a user is assigned to only one contribution zone 300′, the content 308 added to the canvas by that user may automatically be placed within the assigned contribution zone 300′. In an embodiment, unauthorized users can view and interact with the contribution zone 300′. For example, although unauthorized users cannot contribute content to the contribution zone 300′, they may be permitted to manipulate content already included therein.

An example of dividing a canvas into a plurality of contribution zones 300′ is described as follows. Using a Cartesian coordinate representation for the canvass, with the origin proximate a centre of the canvas, each of quadrants (x>0, y>0); (x>0, y<0); (x<0, y>0) (x<0, y<0) may be defined as contribution zones 300′ to which different subsets of users may be assigned. In one implementation, authorized users in one quadrant may view the other three quadrants and manipulate the content therein, but may only contribute content to the quadrant in which they are authorized. In another implementation, only authorized users can view and interact with the contribution zone 300′.

As another example, referring to FIG. 3c, a segregated zone is shown generally by numeral 300″. The segregated zone 300″ includes all of the properties of the contribution zone 300′. However, the segregated zone 300″ functions as a sub-workspace within the universal workspace. That is, when a user is assigned to the segregated zone 300″, that user is locked into the segregated zone 300″ and cannot view or access any other zones 300 within the canvas. Alternatively, even if there are no other zones, the users of the segregated zone may only see their zone and not any other part of the canvass or universal workspace. Depending on the implementation, the segregated zone 300″ may be visible to users who are not assigned to a segregated zone 300″. However, even if the segregated zone 300″ is visible, such users will not be able to contribute content to, or interact with, the segregated zone 300″.

For example, as illustrated in FIG. 3c, there are two segregated zone 300″, Zone 1 and Zone 2. Zone 1 has two authorized users, AA and BB. Zone 2 has two authorized users, CC and DD. When accessing the collaboration application, authorized users AA and BB will only have full access to Zone 1. In some embodiments Zone 2 may not even be visible to them. In other embodiments, unauthorized users may view but not manipulate or add content to zone 2. Similarly, when accessing the collaboration application, authorized users CC and DD will only have full access to Zone 2. Zone 1 may not even be visible to them. Depending on the implementations, Zone 1 and Zone 2 may be visible to other users EE and FF (not shown) who are unauthorized to the segregated zones 300″. However, a super user such as a teacher will have full access to all zones and may alter the zones' characteristics.

The segregated zone 300″ may be converted to a contribution zone 300′ or basic zone 300 once a predefined task associated with the segregated zone 300″ is complete. Once the segregated zone 300″ is converted, the user will no longer be locked therein and will only be subject to the rules and restrictions of the zone to which the segregated zone is converted. For example, there may be no restrictions on the zone so that the users assigned to the zone may now freely use the entire workspace with full access to create, view, delete and manipulate content as well as pan and zoom-in/zoom-out throughout the workspace.

Referring once again to FIG. 3c, if Zone 1 is converted to a basic zone 300, then the users AA and BB will be able to see other zones, and other users, except CC and DD, will be able to provide content to Zone 1. If Zone 2 is converted to a basic zone 300, then the users CC and DD will be able to see other zones, and other users, except AA and BB, will be able to provide content to Zone 2. If Zone 1 and Zone 2 are converted to basic zones 300, then the users AA, BB, CC, and DD will be able to see other zones, and other users will be able to provide content to Zone 1 and Zone 2.

If Zone 1 is converted to a contribution zone 300′, then the users AA and BB will be able to see other zones. However, only users AA and BB will be permitted to provide content to Zone 1. If Zone 2 is converted to a contribution zone 300′, then the users CC and DD will be able to see other zones. However, only users CC and DD will be able to provide content to Zone 2. If Zone 1 and Zone 2 are converted to contribution zones 300′, then the users AA, BB, CC, and DD will be able to see other zones, but only users AA and BB will be able to provide content to Zone 1 and only users CC and DD will be able to provide content to Zone 2.

The segregated zone 300″ can be converted into another type of zone in response to a number of different criteria. For example, the segregated zone 300″ can be converted automatically once the users assigned therein have provided content that meets predefined criteria. As another example, the segregated zone 300″ can be converted automatically after a predefined period of time. As yet another example, the super user can convert the segregated zone 300″ manually once the super user decides either enough time has passed or sufficient content has been provided by the users.

Any of the basic zone 300, contribution zone 300′ and segregation zone 300″ can also be removed so the content included therein becomes part of the canvas without any of the features and restrictions provided by the zones.

Yet further, the zones 300, 300′and 300″ can overlap to provide additional levels of collaboration between users. Referring to FIG. 3d, a pair over overlapping zones is illustrated generally by numeral 350. As shown, a portion 352 of a first zone 354 and a second zone 356 overlap. The portion 352 will also be referred to as the overlap zone 352. Overlapping zones 300, 300′, and 300″ behave similar to set diagrams, or Venn diagrams.

If the first zone 354 and the second zone 356 are both basic zones 300, then the behaviour of the overlap zone 352 is no different than the rest of the first zone 354 and the second zone 356.

If the first zone 354 is a basic zone 300 and the second zone 356 is a contribution zone 300′, then the behaviour of the overlap zone 352 mimics the first zone 354. This allows users of the second zone 356 to interact with other, unauthorized users within the second zone 356. Similarly, if the second zone 356 is a basic zone 300 and the first zone 354 is a contribution zone 300′, then the behaviour of the overlap zone 352 mimics the second zone 356.

If the first zone 354 is a basic zone 300 and the second zone 356 is a segregated zone 300″, then the behaviour of the overlap zone 352 mimics the first zone 354. This allows users of the second zone 356 to interact with other, unauthorized users who would otherwise be invisible to the users of the second zone 356. Similarly, if the second zone 356 is a basic zone 300 and the first zone 354 is a segregated zone 300″, then the behaviour of the overlap zone 352 mimics the first zone 354.

If both the first zone 354 and the second zone 356 are contribution zones 300′, then the behaviour of the overlap zone 352 mimics the contribution zone 300′. However, the users from both the first zone 354 and the second zone 356 can contribute content in the overlap zone 352.

If the first zone 354 is a contribution zone 300′ and the second zone 356 is a segregated zone 300″, then the behaviour of the overlap zone 352 mimics the first zone 354. This allows users of the second zone 356 to interact with the users of the first zone 354, who would otherwise be invisible to the users of the second zone 356. Similarly, if the second zone 356 is a contribution zone 300 and the first zone 354 is a segregated zone 300″, then the behaviour of the overlap zone 352 mimics the first zone 354.

If both the first zone 354 and the second zone 356 are segregation zones 300″, then the behaviour of the overlap zone 352 mimics the segregation zone 300″. However, the users from both the first zone 354 and the second zone 356 are only visible to each other and can only contribute content in the overlap zone 352.

As described above, different zone types can be made more or less restrictive depending on how the zones are to be used. For example, the zones can be restricted so that the authorized users can only view the zone to which their access is restricted. In cases where there is a clear leader, such as in a classroom environment with teachers and students, for example, the leader could be designated as the super user and given special privileges to control and monitor all zones, regardless of its restrictions and permissions.

Further, the zones 300, 300′, 300″ can be given backgrounds, including template backgrounds, thereby providing group or individual activity spaces within each zone 300, 300′, 300″.

Yet further, although the contribution zone 300′ and the segregation zone 300″ are described as types of zones, other types of zones will become apparent to a person skilled in the art.

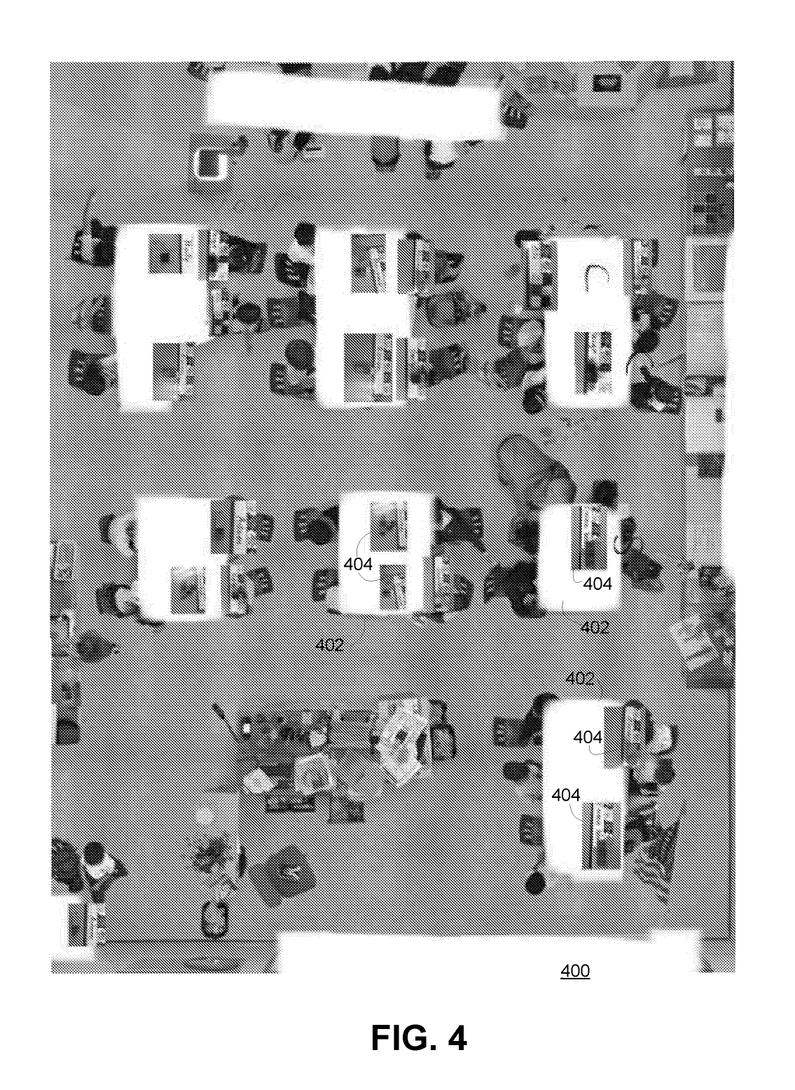

Referring to FIG. 4, a sample plan onto which different zones 300 can be overlaid is illustrated generally by numeral 400. In this example, the plan is a classroom. The classroom plan 400 includes a plurality of students' desks 402. Each student's desk 402 in the classroom plan 400 has an associated zone 404. The teacher can manipulate the zones 404 so that the students work individually, in small groups, large groups and the like, as discussed above. FIG. 4 illustrates an example of a physical plan, in which the zones 404 are based on location of the users. In another example, a logical plan can also be created. The logical plan can be based on an organization chart, for example. Thus, users can be grouped based on working relationships rather than physical location. Yet further, a combination of the two types of plans may also be used.

As described above, the collaboration application is executed via a web browser application executing on the user's computing device. In an alternative embodiment, the collaboration application is implemented as a standalone application running on the user's computing device. The user gives a command (such as by clicking an icon) to start the collaboration application. The application collaboration starts and connects to the remote host server using the URL. The collaboration application displays the canvas to the user along with the functionality accessible through buttons and/or menu items.

In the embodiments described the content in the zone is automatically manipulate using event handlers. Alternatively, callback procedures may be used. In this implementation, each content object may register its event handler routine as a callback procedure with a contact event monitor. In the event that the zone is manipulated, the contact event monitor calls the registered callback procedures or routines for each of the affected content objects such that each graphical object is manipulated.

In another embodiment, bindings may be used. In this implementation, the event handlers of each content object may be bound to a function or routine that is provided, for example, in a library. When the zone it to be manipulated, the corresponding bound library routine is used to process the manipulation.

Although in embodiments described above, the interactive input system is described as being in the form of an LCD screen employing machine vision, those skilled in the art will appreciate that the interactive input system may take other forms and orientations. The interactive input system may employ FTIR, analog resistive, electromagnetic, capacitive, acoustic or other technologies to register input. For example, the interactive input system may employ: an LCD screen with camera based touch detection (such as SMART Board™ Interactive Display model 8070i); a projector-based interactive whiteboard (IWB) employing analog resistive detection (such SMART Board™ IWB Model 640); a projector-based IWB employing a surface acoustic wave (WAV); a projector-based IWB employing capacitive touch detection; a projector-based IWB employing camera based detection (such as SMART Board™ model SBX885ix); a table (such as SMART Table™, and described in U.S. Patent Application Publication No. 2011/069019 assigned to SMART Technologies ULC of Calgary); a slate computer (such as SMART Slate™ Wireless Slate Model WS200); a podium-like product (such as SMART Podium™ Interactive Pen Display) adapted to detect passive touch (for example fingers, pointer, and the like, in addition to or instead of active pens); all of which are provided by SMART Technologies ULC of Calgary, Alberta, Canada.

Other interactive input systems that utilize touch interfaces such as for example tablets, smartphones with capacitive touch surfaces, flat panels having touch screens, track pads, interactive tables, and the like may embody the above described interactive interface.

Those skilled in the art will appreciate that the host application described above may comprise program modules including routines, object components, data structures, and the like, embodied as computer readable instructions stored on a non-transitory computer readable medium. The non-transitory computer readable medium is any data storage device that can store data. Examples of non-transitory computer readable media include for example read-only memory, random-access memory, CD-ROMs, magnetic tape, USB keys, flash drives and optical data storage devices. The computer readable instructions may also be distributed over a network including coupled computer systems so that the computer readable program code is stored and executed in a distributed fashion.

Although embodiments have been described above with reference to the accompanying drawings, those of skill in the art will appreciate that variations and modifications may be made without departing from the scope thereof as defined by the appended claims.

What is claimed is:

1. A method for automatically grouping objects on a canvas in a collaborative workspace, the method comprising:
defining at least one zone within the canvas into which at least a subset of a plurality of users of the collaborative workspace can contribute content;
in response to a user-based manipulation of the zone, automatically manipulating all of the content contained within the zone; and
in response to a user-based manipulation, by one of the subset of the plurality of users, of selected ones the content within the zone, manipulating only the selected ones of the content.

2. The method of claim 1 further comprising restricting access to the zone to predefined authorized users.

3. The method of claim 2, wherein the access to the zone is restricted such that only the authorized users can contribute content to the zone.

4. The method of claim 3, wherein unauthorized users can interact with the zone.

5. The method of claim 3, wherein only the authorized users can view the zone to which their access is restricted.

6. The method of claim 3, wherein the authorized users can only view the zone to which their access is restricted.

7. The method of claim 4, wherein restrictions to the zone are modified in response to predefined criteria.

8. The method of claim 7, wherein the predefined criteria includes one or more of a predefined content requirement, a predefined time period, and intervention of a super user.

9. The method of claim 1 further comprising defining a plurality of zones.

10. The method of claim 9, wherein at least a pair of the plurality of zones overlap, and the overlapping section of the pair of zones behaves as a combined set of the restrictions of each of the pair of zones.

11. The method of claim 9, wherein the plurality of zones are mapped to a plan.

12. The method of claim 11, wherein the plan is a physical plan or a logical plan.

13. An interactive input system comprising:
a touch surface;
memory comprising computer readable instructions; and
a processor configured to implement the computer readable instructions to:
provide a canvas on the touch surface via which a plurality of users can collaborate;
define at least one zone within the canvas into which users can contribute content;
in response to a user-based manipulation of the at least one zone, automatically manipulate the content contained with the at least one zone; and
in response to a user-based manipulation of selected ones the content with the at least one zone, automatically manipulate only the selected ones of the content.

14. A method of subdividing a digital canvass into a plurality of zones, the method comprising:
creating a first zone having a first subset of users authorized to contribute content therein;
creating a second zone having a second subset of users authorized to contributed content therein;
wherein only ones of the first subset of users can place digital content into the first zone and only one of the second subset of users can place digital content into the second zone.

15. The method of claim 14, further comprising overlapping at least a portion of the first zone with at least a portion of the second zone to create an overlap portion; wherein a logical combination of the first subset of users and the second subset of users can place digital content in the overlap portion.
